(19) United States
(12) Patent Application Publication
(10) Pub. No.: US 2021/0103886 A1
(43) Pub. Date: Apr. 8, 2021

(54) PACKAGING ASSISTANCE DEVICE, PACKAGING ASSISTANCE METHOD, AND STORAGE MEDIUM

(71) Applicants: Kabushiki Kaisha Toshiba, Tokyo (JP); Toshiba Infrastructure Systems & Solutions Corporation, Kawasaki-shi (JP)

(72) Inventors: Kentaro SEZAKI, Kawasaki (JP); Tomoyuki HAMAMURA, Shinagawa (JP); Takuma AKAGI, Meguro (JP); Akihisa TAKADA, Ota (JP)

(73) Assignees: Kabushiki Kaisha Toshiba, Tokyo (JP); Toshiba Infrastructure Systems & Solutions Corporation, Kawasaki-shi (JP)

(21) Appl. No.: 17/126,533

(22) Filed: Dec. 18, 2020

Related U.S. Application Data
(63) Continuation of application No. PCT/JP2019/023221, filed on Jun. 12, 2019.

(30) Foreign Application Priority Data
Jun. 25, 2018 (JP) 2018-120219

(51) Int. Cl. G06Q 10/08; B65B 59/00

(52) U.S. Cl. CPC G06Q 10/0832; B65B 59/003; B65B 59/001; G06Q 10/08345

(57) ABSTRACT

A packaging assistance device according to an embodiment includes: an acquirer; a determiner; and a display. The acquirer acquires, for each group including one or more articles to be shipped to the same destination, article information pertaining to the articles. The determiner determines, based on the article information acquired by the acquirer, a packaging material for packing the articles included in the group among a plurality of packaging materials having different accommodation space sizes and a method of packing the article having a sequence in which the article included in the group is to be packed in the packaging material. The display displays information indicating the packaging material and the packing method determined by the determiner.

### CROSS-REFERENCE TO RELATED APPLICATIONS

This application is a continuation patent application of International Application No. PCT/JP2019/023221, filed Jun. 12, 2019, which claims priority to Japanese Patent Application No. 2018-120219, filed Jun. 25, 2018. Both applications are hereby expressly incorporated by reference herein in their entireties.

### FIELD

Embodiments described herein relate generally to a packaging assistance device, a packaging assistance method, and a storage medium.

### BACKGROUND

With the widespread use of online shopping, there is ever-increasing demand for greater overall efficiency of distribution. For example, when the size of cardboard boxes used for packaging products is too large for the products, the efficiency of a shipping company may be low in some cases. On the other hand, if cardboard boxes tight-fit for the size of products are prepared and used for packaging, the work efficiency of a company which handles packaging work may be reduced in some cases. For this reason, it is difficult to improve the overall efficiency of distribution in many cases.

### BRIEF DESCRIPTION OF THE DRAWINGS

FIG. 1 is a diagram explaining an example of a flow of packaging work.

FIG. 2 is a diagram showing an example of a constitution of a packaging assistance device in an embodiment.

FIG. 3 is a diagram showing an example of the details of product group information.

FIG. 4 is a diagram showing an example of the details of product information.

FIG. 5 is a diagram showing an example of the details of packaging material information.

FIG. 6 is a diagram showing an example of a setting screen configured to set a priority criterion.

FIG. 7 is a flowchart describing an example of a process for setting a priority criterion.

FIG. 8 is a flowchart describing an example of processing using the packaging assistance device.

FIG. 9 is a flowchart describing an example of processing using a determiner.

FIG. 10 is a flowchart describing an example of the processing using the determiner.

FIG. 11 is a diagram showing an example of an image.

FIG. 12 is a diagram showing an example of an image.

FIG. 13 is a diagram showing an example of an image.

FIG. 14 is a diagram showing an example of an image.

FIG. 15 is a diagram showing an example of an image.

FIG. 16 is a diagram showing an example of a series of images.

### DETAILED DESCRIPTION

According to one embodiment, a packaging assistance device may include, but is not limited to, a display, an acquirer, a determiner, and an output controller. The acquirer acquires, for each group including one or more articles to be shipped to the same destination, article information pertaining to the articles. The determiner determines, based on the article information acquired by the acquirer, a packaging material for packing the articles included in the group among a plurality of packaging materials having different accommodation space sizes and a method of packing the articles including a sequence in which the articles included in the group are to be packed in the packaging materials. The output controller causes the display to display information indicating the packaging materials and the packing method determined by the determiner.

Hereinafter, an image-processing apparatus, a packaging assistance device, a packaging assistance method, and a storage medium of an embodiment will be possible to contribute to improvement in overall efficiency of distribution.

A packaging assistance device, a packaging assistance method, and a storage medium in an embodiment will be described below with reference to the drawings. An example in which an object to be packaged in the embodiment is a product will be described below. Here, the object to be packaged in the embodiment is not limited to a product and may be an article (for example, a gift) or the like other than a product.

An example of a flow of packaging work assisted using the packaging assistance device 100 in an embodiment will be first described. The packaging work includes, for example, picking work and packaging work. The picking work is work in which a product to be shipped is selected (taken out) and transported along a transportation path. The transportation path may be configured of a belt conveyor or may include a moving path using a movable container. When a plurality of products are to be shipped to the same destination, work in which the plurality of products are put together is also included in the picking work. The packaging work is work in which products or the like which have been selected through the picking work and transported along the transportation path are packed in a packaging material (for example, a cardboard box or a packaging bag).

Inspection work may be performed by a worker or a robot between the picking work and the packaging work. The inspection work is work in which a check concerning whether a product selected through the picking work matches the details of a slip. The details of the slip are, for example, the details of an order settled in Internet shopping and include information, a destination, a shipping method, and the like pertaining to an ordered product.

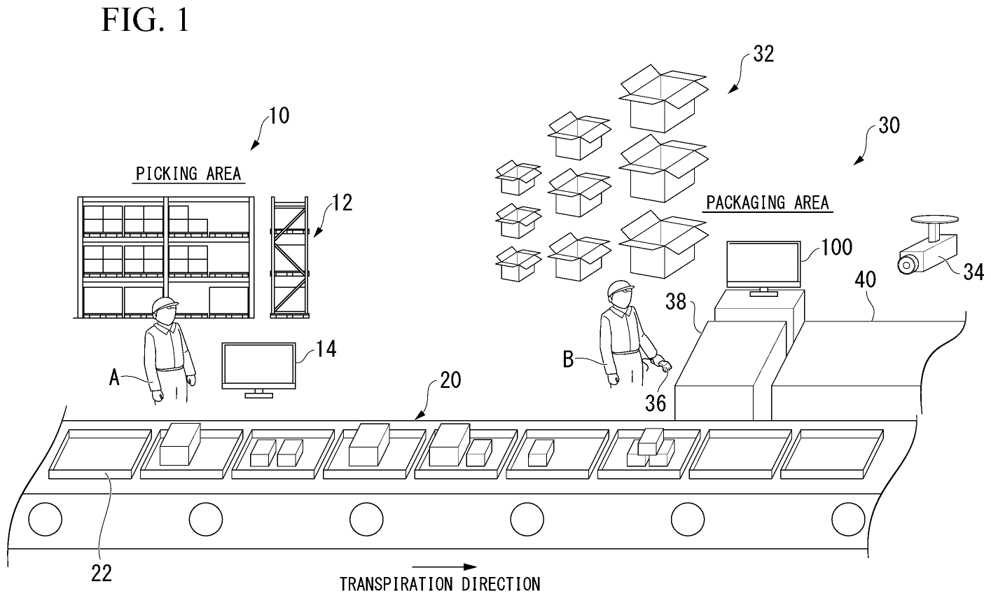

FIG. 1 is a diagram explaining an example of a flow of packaging work. Picking work is performed by a worker A or a robot in a picking area 10. The picking area 10 has a display shelf 12 prepared therein and various products are displayed on this display shelf 12. The picking area 10 has a terminal device 14 configured to display the details of a slip and the like installed therein.

The packaging work is performed by a worker B in a packaging area 30. The packaging area 30 has a packaging material stock 32 prepared therein. The packaging material stock 32 includes, for example, materials of the same shipping company, which are materials having different accommodation spaces, materials having different shipping companies, and the like.

Also, the packaging area 30 may have a detecting apparatus 34 such as a camera installed therein. The detecting apparatus 34 captures an image of a product which has reached the packaging area 30 and acquires the captured image data. Furthermore, the packaging area 30 has the packaging assistance device 100 installed therein which assists the worker B in the packaging work.

For example, a conveyor 20 is arranged between the picking area 10 and the packaging area 30. The conveyor 20 has, for example, a constitution in which a plurality of trays 22 are conveyed. This conveyor 20 has a constitution in which each of the trays 22 is tilted so that a bottom surface thereof faces the outside of the conveyor 20 through control of a control device (not shown). With this constitution, articles placed on the tray 22 can flow to a branch line branching from a main line of the conveyor 20. Although the conveyor 20 has a simple constitution to simplify the description in the example of FIG. 1, a complicated constitution in which a plurality of picking areas 10 and a plurality of packaging areas 30 are connected may be provided.

For example, the worker A collects products belonging to the same product group while checking the details of the slip displayed on a monitor of the terminal device 14 and places the products on the same tray 22. Products belonging to the same product group may be collected until the products reach the packaging area 30 and products which are not placed in the picking area 10 may be added to the tray 22 which is being conveyed on the conveyor 20.

A product group is, for example, a product group ordered through Internet shopping and includes one or more products to be shipped to the same destination at the same timing. For example, the product group is a product group associated with one slip number created through one order.

The worker B performs work which will be described later while checking guidance information displayed on the monitor of the packaging assistance device 100. First, the packaging assistance device 100 acquires identification information of a product group which is a target of the next packaging work. For example, the packaging assistance device 100 acquires a product group ID corresponding to a product placed on the tray 22 based on the image data acquired using the detecting apparatus 34. The product group ID may be acquired, for example, by reading a barcode using a barcode reader 36 operated by the worker B. This barcode is printed on, for example, a paper slip placed on the tray 22 together with a product. The product group ID is identification information used for identifying each product group. The information used for identifying the product group may be a slip number used for identifying each slip, an order number used for identifying each order, or the like.

The packaging assistance device 100 presents the worker B with a type of packaging material configured to pack a product associated with this product group ID and a method of packing a product in a packaging material based on the acquired product group ID. The worker B checks a “type of packaging material” displayed on the monitor of the packaging assistance device 100, takes out the presented type of packaging material from among the packaging material stock 32, and places the product on a workbench 38. Subsequently, the worker B packs the product placed on the tray 22 in the packaging material while checking the “packing method” displayed on the monitor of the packaging assistance device 100.

After packing all of the products in the packaging material, the worker B closes the packaging material and attaches a shipping label on a surface of the packaging material. Destination information and the like are printed on the shipping label. Furthermore, the worker B places the closed packaging material on the conveyor 40. The conveyor 40 conveys the placed packaging material toward a sorting area.

### [Packaging Assistance Device 100]

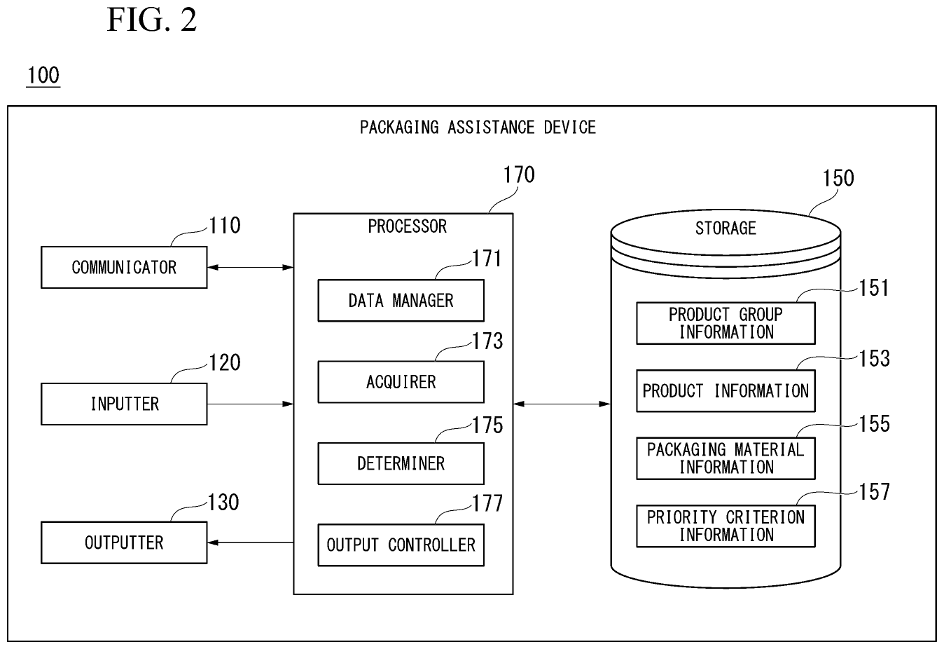

FIG. 2 is a diagram showing an example of a constitution of the packaging assistance device 100 in the embodiment. The packaging assistance device 100 includes, for example, a communicator 110, an inputter 120, an outputter 130, a storage 150, and a processor 170. The communicator 110 includes hardware configured to be connected to a network NW using a cellular network, a Wi-Fi network, or the like. For example, the communicator 110 includes an antenna, a transmission/reception device, and the like. Furthermore, the communicator 110 may include, for example, a communication interface such as a network interface card (NIC). The inputter 120 includes, for example, a part or all of a touch panel TP integrally formed with the outputter 130, various keys, buttons, dial switches, a mouse, a microphone, and the like. The outputter 130 includes, for example, a display such as a liquid crystal display (LCD) and an organic electroluminescence (EL) display device. The outputter 130 may include a speaker, a lamp, and the like.

The storage 150 is implemented by, for example, a random-access memory (RAM), a read-only memory (ROM), a flash memory, an SD card, a register, or the like. The storage 150 may be an external storage device such as a network-attached storage (NAS) which is accessible using the packaging assistance device 100 over a network. The storage 150 stores, for example, the product group information 151, the product information 153, the packaging material information 155, priority criterion information 157, and the like.

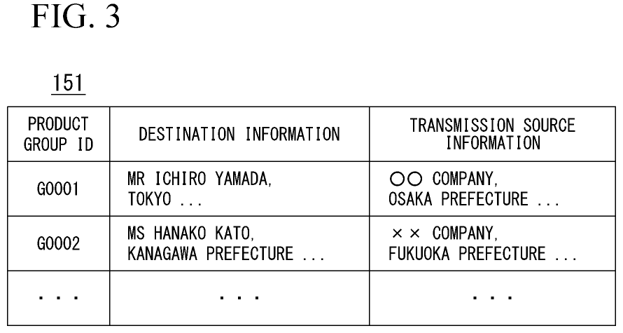

FIG. 3 is a diagram showing an example of the details of the product group information 151. The product group information 151 is, for example, information obtained by associating destination information and transmission source information with a product group ID. The destination information includes an addressee and an address. A transmission source includes a name and an address of a transmission source.

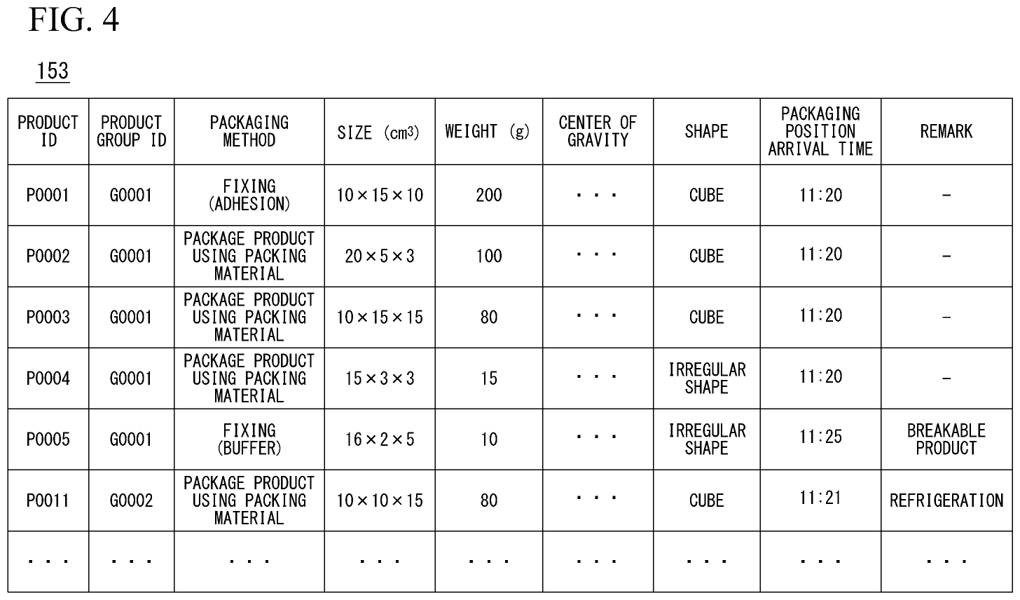

FIG. 4 is a diagram showing an example of the details of the product information 153. The product information 153 is, for example, information obtained by associating a product group ID, a packaging method, a size, a weight, a center of gravity position, a shape, a packaging position arrival time, and a remark with a product ID. The product ID corresponds to identification information used for identifying each product. The packaging method is a method of packaging a product. The packaging method includes, for example, a method of fixing a product in a packaging material, a method of wrapping a product using a packaging material. A method of fixing a packaging material includes an adhesive fixing method of adhering a material obtained by fixing the packaging material in a plate material constituted of cardboard using a sheet made of a vinyl material to a bottom surface of the packaging material, a buffer fixing method in which a buffer is packed and fixed, and the like.

The size corresponds to information indicating a size of a product (hereinafter referred to as “product size information”). The size is represented by, for example, width×height×depth of a product. When a product requires individual packaging, the size further includes information indicating a size of a product which has been subjected to individual packaging (hereinafter referred to as “packaged size information”). When fixing using the adhesive fixing method is required, the size further includes information indicating a size in a state in which a product has been fixed in a plate material with vinyl (hereinafter referred to as “adhesive fixed size information”). In the case of a deformable product, the size further includes information indicating a size of a product which has been deformed (hereinafter referred to as “deformed size information”).

The weight corresponds to information indicating a weight of a product (hereinafter referred to as “product weight information”). The center of gravity position corresponds to information indicating a center of gravity position of a product (hereinafter referred to as “product center of gravity position information”). The shape corresponds to information indicating a shape of a product (hereinafter referred to as “product shape information”). A shape of a product includes a cube, a cylinder, an irregular shape, and the like. An irregular shape includes, for example, a case in which packaging is performed in accordance with a shape of a product and the shape cannot be defined such as a toothbrush, a case in which a product is not formed in a defined shape such as toothpaste, and the like. The packaging position arrival time corresponds to information indicating a predicted time at which a product reaches the packaging area 30 (hereinafter referred to as “packaging position arrival time information”). The remark includes information pertaining to other products such as refrigerated goods, breakable goods or the like.

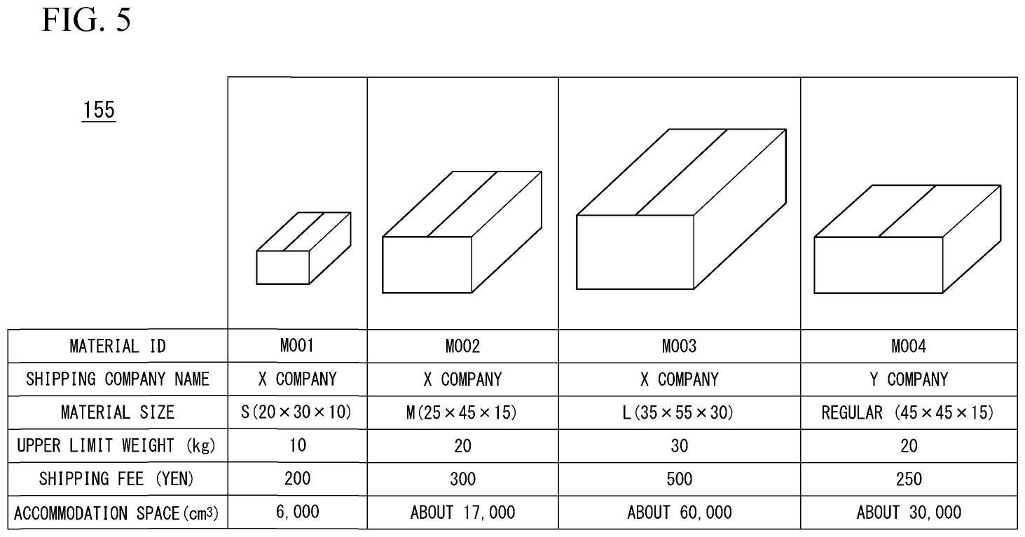

FIG. 5 is a diagram showing an example of the details of the packaging material information 155. The packaging material information 155 is, for example, information obtained by associating a shipping company name, a material size, an upper limit weight, a transportation fee, and an accommodation space with a material ID. The material ID corresponds to identification information used for identifying each packaging material. The material size corresponds to information indicating a size of a packaging material. The material size is represented by, for example, width×height×depth. The upper limit weight corresponds to a maximum weight in which a product can be shipped at a shipping fee. The shipping fee is a fee determined between a user and a corresponding shipping company. As illustrated in the drawings, the shipping fee may include information pertaining to two or more different shipping companies. The accommodation space corresponds to, for example, an internal capacity of a packaging material.

Referring to FIG. 2 again, the processor 170 includes, for example, a data manager 171, an acquirer 173, a determiner 175, and an output controller 177. Some or all of these constituent elements are realized, for example, using a processor such as a central processing unit (CPU) executing a program (software) stored in the storage 150. Furthermore, some or all of these constituent elements may be implemented using hardware (including a circuit section: a circuitry) such as a large-scale integration (LSI), an application-specific integrated circuit (ASIC), a field-programmable gate array (FPGA), and a graphics-processing unit (GPU) or may be realized in cooperation of software and hardware. The program may be stored in advance in a storage device such as a hard disk drive (HDD) or a flash memory, may be stored in an attachable/detachable storage medium such as a DVD or a CD-ROM, and may be installed when a storage medium is installed in a drive device. Furthermore, the processor 170 can execute various processes which will be described later based on the various information stored in the storage 150.

The data manager 171 stores information received using the communicator 110 in the storage 150. The information received using the communicator 110 includes existing data such as information pertaining to a product, real-time data acquired using the detecting apparatus 34, and the like. Furthermore, the data manager 171 stores information input by the worker B using the inputter 120 in the storage 150.

The acquirer 173 acquires a product group ID indicating a product group which is the next working target. For example, the acquirer 173 may acquire a product group ID included in an image using a character recognition technique by performing image analysis on image data received from the detecting apparatus 34 using the communicator 110. Furthermore, the acquirer 173 may acquire a product group ID based on the information read by the barcode reader 36. The barcode reader 36 may be configured to be included in the inputter 120 or may be configured to perform communication using the communicator 110.

The acquirer 173 acquires product information for each product group. For example, the acquirer 173 reads the acquired product information corresponding to the product group ID from the product information 153 of the storage 150. The acquirer 173 may acquire product information using the communicator 110 by accessing an external storage.

The determiner 175 determines a type of packaging material (hereinafter referred to as a “work material”) in which a product which is a working target is packed among a plurality of packaging materials having different accommodation space sizes based on the information acquired by the acquirer 173. Furthermore, the determiner 175 determines a method of packing each product included in a product group in a work material. The packing method includes information indicating which product is to be packed in which position in the packaging material. That is to say, the determiner 175 determines an arrangement position when a product is packed in a packaging material and a sequence in which a product is packed in a packaging material.

The determiner 175 determines, for example, a packaging material which satisfies a predetermined priority criterion as a work material. The priority criterion may be determined in accordance with, for example, a company's shipping policy. The priority criterion includes a plurality of criterions each having different priority items and includes, for example, a “material size priority,” a “shipping fee priority,” and a “conveyor loading sequence priority.” In the material size priority, a work material in which a size (an accommodation space) of a packaging material is minimized is determined as a work material. In the shipping fee priority, a work material in which a shipping fee for shipping all products included in a product group is the smallest is determined as a work material. For example, a method of packing a product using two divided packaging materials can reduce a shipping fee in some cases. In the conveyor loading sequence priority, a work material in which a difference between packaging position arrival times is the smallest between products packed in the same packaging material is determined as a work material. In the conveyor loading sequence priority, a work material in which a difference between packaging position arrival times is smaller than or equal to a threshold value between products packed in the same packaging material is not limited thereto and may be determined as a work material.

The output controller 177 causes the outputter 130 to output the determination result determined by the determiner 175. For example, the output controller 177 generates display data used for displaying a guidance screen configured to guide the worker B in packaging work and causes the outputter 130 to output the generated display data. The guidance screen includes, for example, a type of work material, a packing method, or the like determined by the determiner 175. A constitution including the display included in the outputter 130 and the output controller 177 may be collectively referred to as a “display” in some cases.

### [Setting of Priority Criterion]

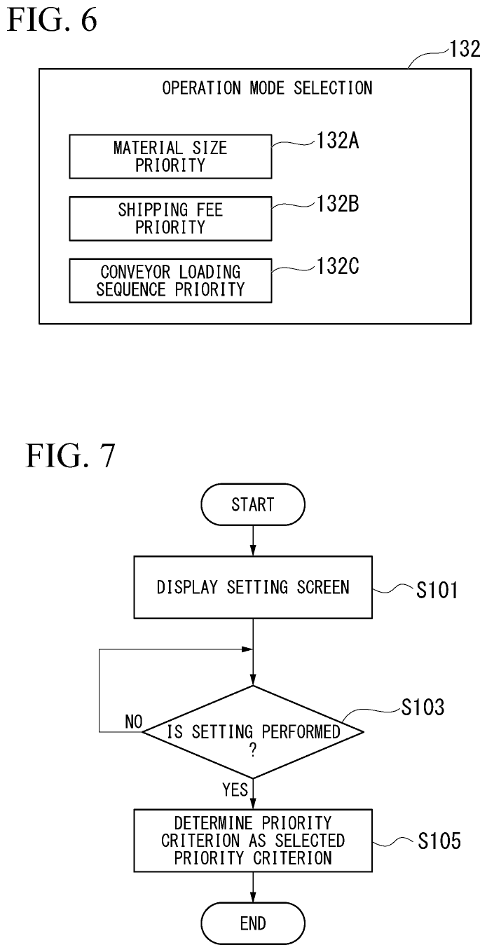

An example of setting of a priority criterion will be described below with reference to FIGS. 6 and 7. FIG. 6 is a diagram showing an example of the setting screen 132 configured to set the priority criterion. The setting screen 132 includes a setting button configured to set each priority criterion. For example, the setting screen 132 includes a setting button 132A configured to set a “material size priority,” a setting button 132B configured to set a “shipping fee priority,” and a setting button 132C configured to set a “conveyor loading sequence priority.” The setting screen 132 may be displayed in an initial operation of the packaging assistance device 100 or may be displayed for each product group.

FIG. 7 is a flowchart describing an example of a process of setting a priority criterion. First, the output controller 177 causes the outputter 130 to display the setting screen 132 (Step S101). Subsequently, the determiner 175 determines whether a priority criterion has been selected using the setting screen 132 based on the input from the inputter 120 (Step S103). When any one of the setting buttons 132A to 132C has been operated by the worker B, the determiner 175 determines a type of operation mode as a priority criterion selected by the worker B and stores the determined type of operation mode in the storage 150 as a part of the priority criterion information 157 (Step S105).

### [Packaging Assistance Process]

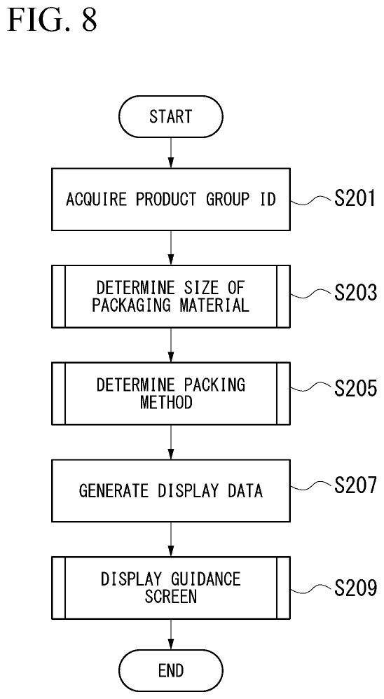

FIG. 8 is a flowchart describing an example of a process using the packaging assistance device 100. First, the acquirer 173 acquires a product group ID indicating a product group which is the next working target. (Step S201). Subsequently, the determiner 175 determines a type of work material (Step S203) and determines a packing method (Step S205). The details of the process of Steps S203 and S205 will be described later. Subsequently, the output controller 177 generates display data used for displaying a guidance image based on the determination results determined by the determiner 175 (Step S207) and causes the outputter 130 to display the guidance image (Step S209)

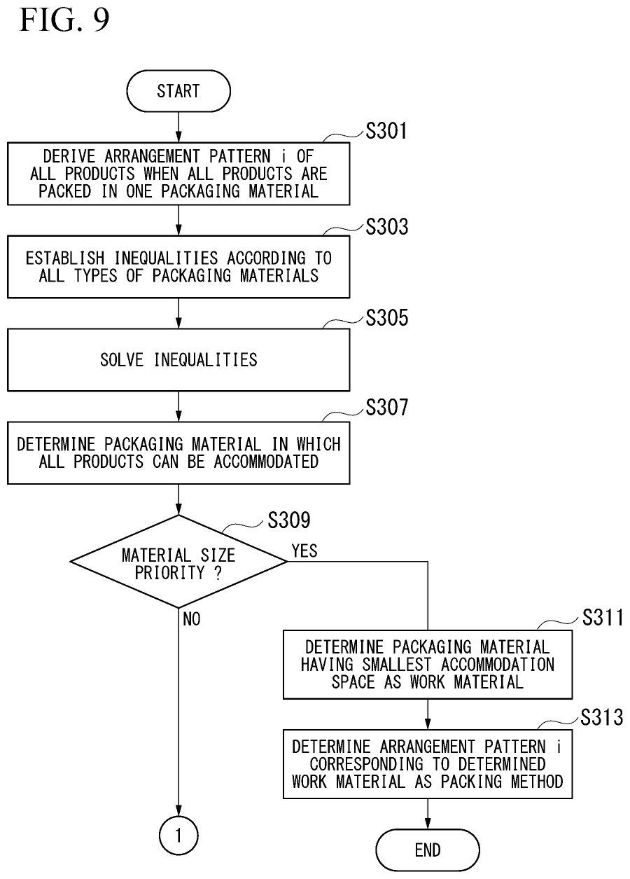

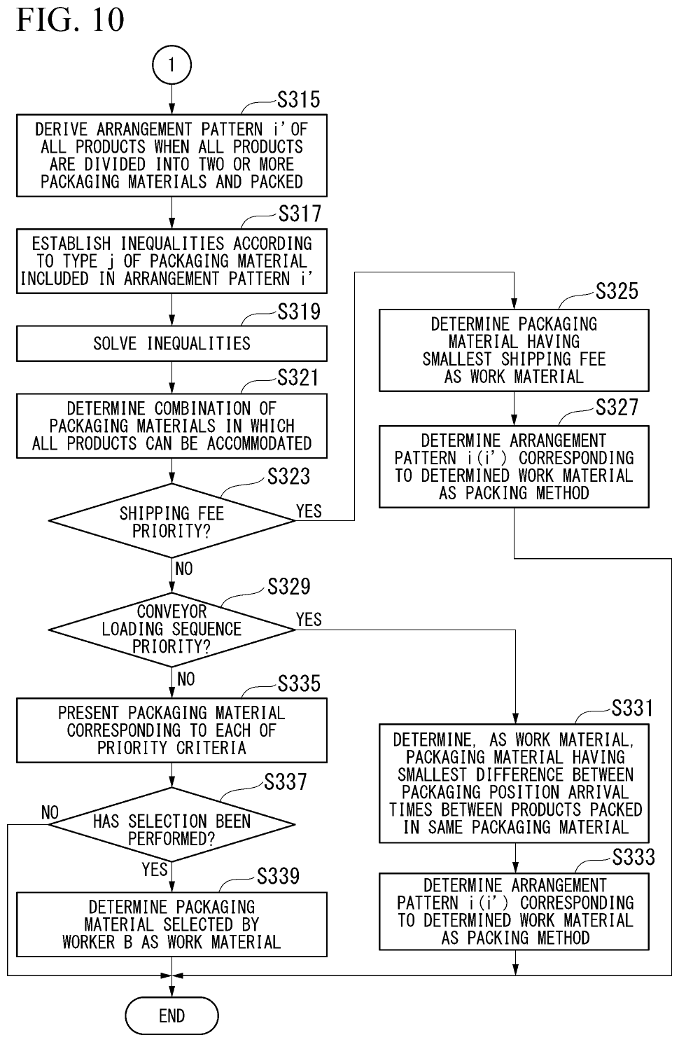

The details of the process using the determiner 175 in Steps S203 and S205 will be described later. FIGS. 9 and 10 are flowcharts describing an example of a process using the determiner 175. Here, an example in which the determiner 175 utilizes linear programming will be described. First, the determiner 175 derives all arrangement patterns i(j) when all products corresponding to a product group ID are packed in one packaging material based on the product size information of the product information 153 (Step S301). The determiner 175 may determine the details of a state associated with size information to be adopted in accordance with the characteristics of a product with reference to the product information 153 and then derive the arrangement pattern i(j) based on the determination result. For example, the determiner 175 may derive the arrangement pattern i(j) based on the packaged size information for a product in which individual packaging using a packaging material is required. The determiner 175 may derive the arrangement pattern i(j) based on the adhesive fixed size information for a product in which individual packaging using adhesive fixation is required. The determiner 175 derives the arrangement pattern i(j) based on the deformed size information for a deformable product. When there are a plurality of possibilities (such as when there are possibilities of both packaging using a packaging material and deformation), the determiner 175 may derive the arrangement pattern i(j) in accordance with each possibility.

In Step S301, the determiner 175 may derive a pattern in which all of the products are arranged on the same plane or may derive a pattern in which a plurality of products are stacked and arranged. In a case in which a pattern in which all of the products are arranged on the same plane is derived, the determiner 175 derives an arrangement pattern in which the sizes of gaps between products are reduced. Furthermore, in the case in which a pattern in which all of the products are arranged on the same plane is derived, the determiner 175 derives an arrangement pattern in which a total weight of products packed in one packaging material is less than or equal to (less than) an upper limit weight with reference to the packaging material information 155 based on the product weight information included in the product information 153. In a case in which the pattern in which a plurality of products are stacked and arranged is derived, the determiner 175 may determine whether products are stacked in accordance with predetermined stacking rules R1 based on the product weight information included in the product information 153. The stacking rules R1 include, for example, that a product having a weight greater than or equal to a threshold value (for example, 5 kg) cannot be stacked above another product, that, when products are stacked, a lighter product is arranged above a heavier product, and the like.

Also, in the case in which the pattern in which a plurality of products are stacked and arranged is derived, the determiner 175 may derive an arrangement pattern in which another product may be stacked thereon when an upper surface of a product has a horizontal shape based on the product shape information included in the product information 153. That is to say, the determiner 175 may not derive an arrangement pattern in which another product is stacked when the upper surface of the product does not have a horizontal shape. Furthermore, in the case in which the pattern in which a plurality of products are stacked and arranged is derived, when a product is a breakable product, the determiner 175 may not derive an arrangement pattern in which another product is stacked above the product based on the remarks included in the product information 153. In addition, in the case in which the pattern in which a plurality of products are stacked and arranged is derived, the determiner 175 may derive a center of gravity position of a packaging material in which a product is packed in the packaging material based on the product center of gravity position information included in the product information 153 and determine an arrangement pattern in accordance with a predetermined center of gravity position rule R2 based on the derived center of gravity position. The center of gravity position rule R2 determines, for example, that a center of gravity position of a packaging material is within a threshold value (for example, that the product is not located at an end of the packaging material) and the like.

In this way, the determiner 175 can determine an arrangement of products in a vertical direction of a packaging material (that is, an arrangement of products to be stacked), which is an arrangement in which predetermined conditions are satisfied, based on the product information 153.

Subsequently, the determiner 175 establishes inequalities according to all types of packaging materials j for each derived arrangement pattern i(j) (Step S303). These inequalities are, for example, inequalities in which the fact that the overall size of all products when all of the products have been arranged in accordance with the arrangement pattern i(j) ((hereinafter referred to as an “overall product size in which products have been arranged”) is smaller than a size represented by width×height×depth of the packaging material is satisfied. Examples of the inequalities are illustrated as follows.

Width Wa of product A+width Wb of product B+ . . . +Wα<width Wj of type of packaging material j.

Height Ha of product A+height Hb of product B+ . . . +Hβ<height Hj of type of packaging material j.

Depth Da of product A+depth Db of product B+ . . . +Dγ<depth Dj of type of packaging material j.

Wα, Hβ, and Dγ are, for example, margins or the like used for packing with a buffer. Wα, Hβ, and Dγ may be 0.

Also, the determiner 175 solves the inequalities established in Step S303 (Step S305) and determines a packaging material in which all products corresponding to the product group ID can be accommodated based on the solution (Step S307). For example, the determiner 175 determines a type of packaging material j in which the inequalities are satisfied as a packaging material in which all products corresponding to the product group ID can be accommodated.

Subsequently, the determiner 175 determines whether the set priority criterion is the “material size priority” with reference to the priority criterion information 157 (Step S309). When it is determined that the set priority criterion is the “material size priority,” the determiner 175 determines a packaging material having the smallest size among the packaging materials determined in Step S307 as a work material (Step S311). Furthermore, the determiner 175 determines a packing method based on an arrangement pattern i(j) corresponding to the packaging material determined as the work material in Step S311 (Step S313). Here, the determiner 175 may determine the arrangement determined in the arrangement pattern i(j) as a packing method or may change the arrangement. For example, the determiner 175 may determine a center of gravity position of a packaging material in which products have been packed in the packaging material based on the product center of gravity position information included in the product information 153 and determine an arrangement position of a product in an accommodation space of the packaging material in accordance with a predetermined center of gravity position rule R2 based on the derived center of gravity position. The center of gravity position rule R2 determines, for example, that the center of gravity position of the packaging material is within a threshold value (for example, that the product is not located at an end of the packaging material) and the like.

In Step S309, when the set priority criterion is not the “material size priority,” the determiner 175 derives an arrangement pattern i′ (j1, j2, . . . ) of a plurality of products when all of the products corresponding to the product group ID are divided into two or more packaging materials and packed based on the product size information of the product information 153 (Step S315). The arrangement pattern i′ (j1, j2, . . . ) includes, for example, an arrangement pattern in which some products corresponding to the product group ID are packed in a packaging material with an S size of an X company and the remaining products corresponding to the product group ID are packed in a packaging material with an M size of the X company. (j1, j2, . . . ) indicates a combination of types of packaging material j in which products are distributed in the arrangement pattern i′ (j1, j2, . . . ).

The determiner 175 derives an arrangement pattern i′ (j1, j2, . . . ) so that the arrangement pattern i(j) described above is derived. The determiner 175 is not limited to this and may derive an arrangement pattern i′ (j1, j2, . . . ) using the following method.

Here, an example of a method of deriving an arrangement pattern i′ will be described. For example, the determiner 175 derives an arrangement pattern i′ (j1, j2, . . . ) in which products having the same packaging method are packed in the same packaging material. Furthermore, the determiner 175 may derive an arrangement pattern i′ (j1, j2, . . . ) in which products that do not fit together are packed in packaging materials having a smaller accommodation space by packing products in the packaging materials in order from the product having the largest volume. In addition, the determiner 175 may derive an arrangement pattern i′ (j1, j2, . . . ) in which products having a difference between packaging position arrival times within a predetermined value are packed in the same packaging material based on the packaging position arrival time information included in the product information 153.

Subsequently, the determiner 175 establishes inequalities according to a combination of types of packaging material j included in the arrangement pattern i′ (j1, j2, . . . ) for each derived arrangement pattern i′ (j1, j2, . . . ) (Step S317). The inequalities are, for example, inequalities in which the fact that sizes of all products distributed in each packaging material in which products are distributed in accordance with the arrangement pattern i′ (j1, j2, . . . ) when the products are arranged (the overall product size in which products have been arranged) are smaller than a size represented by width×height×depth of each packaging material having the products distributed therein is satisfied. Examples of the inequalities are illustrated as follows. The example illustrated below includes an example in which a product A, a product B, and the like are arranged in a packaging material of a type j1 and a product C, a product D, and the like are arranged in a packaging material of a type j2.

Width Wa of product A+width Wb of product B+ . . . +Wα1<width Wj1 of type of packaging material j1

Height Ha of product A+height Hb of product B+ . . . +Hβ1<height Hj1 of type of packaging material j1

Depth Da of product A+depth Db of product B+ . . . +Dγ1<depth Dj1 of type of packaging material j1

Wα1, Hβ1, and Dγ1 are, for example, margins or the like used for packing a buffer. Wα1, Hβ1, and Dγ1 may be 0.

Width Wa of product C+width Wb of product D+ . . . +Wα2<width Wj2 of type of packaging material j2

Height Ha of product C+height Hb of product D+ . . . +Hβ2<height Hj2 of type of packaging material j2

Depth Da of product C+depth Db of product D+ . . . +Dγ2<depth Dj2 of type of packaging material j2

Wα2, Hβ2, and Dγ2 are, for example, margins or the like used for packing a buffer. Wα2, Hβ2, and Dγ2 may be 0.

Also, the determiner 175 solves the inequalities established in Step S317 (Step S319) and determines a combination of packaging materials in which all the products corresponding to the product group ID can be accommodated based on the solution (Step S321). For example, the determiner 175 may determine a type of packaging material j in which the inequalities are satisfied as a packaging material in which all products corresponding to the product group ID can be accommodated.

Subsequently, the determiner 175 determines whether the set priority criterion is the “shipping fee priority” with reference to the priority criterion information 157 (Step S323). When it is determined that the set priority criterion is the “shipping fee priority,” the determiner 175 determines, as a work material, a packaging material with the lowest shipping fee per product group between the packaging material determined in Step S307 and the packaging material determined in Step S321 (Step S325). Furthermore, the determiner 175 determines a packing method based on the arrangement pattern i corresponding to the packaging material determined as the work material in Step S325 (Step S327). Thus, the determiner 175 can determine, as a work material, a packaging material with the lowest shipping fee per product group based on the comparison result between a shipping fee when all products included in a product group are accommodated in one packaging material and a shipping fee when all of the products included in the product group are divided into two or more packaging materials and accommodated.

In Step S323, when the set priority criterion is not the “shipping fee priority,” the determiner 175 determines whether the set priority criterion is the “conveyor loading sequence priority” with reference to the priority criterion information 157 (Step S329). When it is determined that the set priority criterion is the “conveyor loading sequence priority,” the determiner 175 determines, as a work material, a packaging material having the smallest difference between packaging position arrival times between products packed in the same packaging material between the packaging material determined in Step S307 and the packaging material determined in Step S321 (Step S331). Furthermore, the determiner 175 determines a packing method based on the arrangement pattern i corresponding to the packaging material determined as the work material in Step S331 (Step S333). Thus, it is possible to minimize a waiting time until the products accommodated in one packaging material reach the packaging area 30 and it is possible to improve the work efficiency in the packaging area 30. For example, this is because, in a case in which a timing at which some products among products belonging to the same product group reach the packaging area 30 is different from a timing at which the other products reach the packaging area 30, the work efficiency in the packaging area 30 may be improved when each of the products is packaged into separate packaging materials in some cases.

In Step S329, when the set priority criterion is not the “conveyor loading sequence priority,” the output controller 177 presents the types of packaging materials in which the respective priority criteria are satisfied, generates output information used for outputting an operation screen configured for selection of any one of these packaging materials, and causes the outputter 130 to output the output information (Step S335). For example, the output controller 177 presents the type of work material determined in Step S311, the type of work material determined in Step S325, and the type of work material determined in Step S331 and causes the outputter 130 to output the operation screen configured to select any one of these. Furthermore, the output controller 177 may display information obtained by associating the type of work material with the priority criteria satisfied by the types of work materials on the operation screen. The determiner 175 determines whether the worker B has selected the packaging material using the operation screen (Step S337). When the worker B has performed selection, the determiner 175 determines the packaging material selected by the worker B as a work material (Step S339).

### [Packing Method]

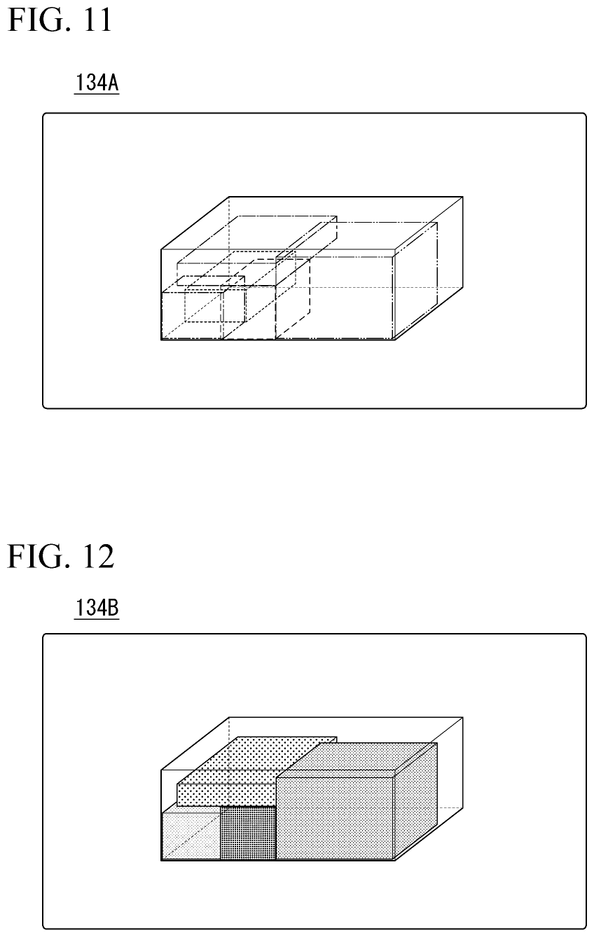

An example of a guidance screen based on a packing method determined by the determiner 175 will be described below with reference to FIGS. 11 to 16. For example, the output controller 177 generates an image 134A or an image 134B indicating a state in which all products scheduled to be packed in work materials have been packed in the work materials (that is, a final form) and causes the outputter 130 to output the generated image 134A or image 134B.

FIG. 11 is a diagram showing an example of the image 134A. The image 134A is a see-through diagram representing a method of packing a plurality of products arranged in a work material. In the image 134A, a figure expressing each product is represented by a diagram showing each shape. The represented see-through diagram may be, for example, a diagram which represents in a see-through manner the surfaces of the shape of each of the products. Thus, this makes it easier to understand arrangement positions or shapes of products arranged on a rear side in the work material when viewed from the front. The transmittance of a surface can be set arbitrarily. When the transmittance of the surface is 100%, this makes it easier to understand arrangement positions of products arranged on a rear side in the work material when viewed from the front. When the transmittance of the surface is higher than or equal to a predetermined lower limit value and lower than or equal to 100% (for example, 50%), this makes it easier to understand shapes or the like of products arranged on a front side in the work material when viewed from the front and this makes it easier to understand shapes or the like of products arranged on a rear side in the work material when viewed from the front.

FIG. 12 is a diagram showing an example of the image 134B. The image 134B is a diagram showing a method of packing a plurality of products arranged in a work material according to images of the exteriors of the products. In the image 134B, each product is represented by an image (an exterior image) in which the respective surfaces represent an exterior form.

In the image 134B, an exterior image of each product may be a simple illustration or an actual package image. This exterior image may be stored in advance in the storage 150 or may be generated by the processor 170 based on the image captured using the detecting apparatus 34.

Also, the image 134B may be an image represented by different colors or patterns configured to distinguish each product, instead of the exterior image of the product.

Also, the output controller 177 may generate an image 134C or an image 134D which represents a sequence in which products are packed in a work material and cause the outputter 130 to output the generated image 134C or image 134D.

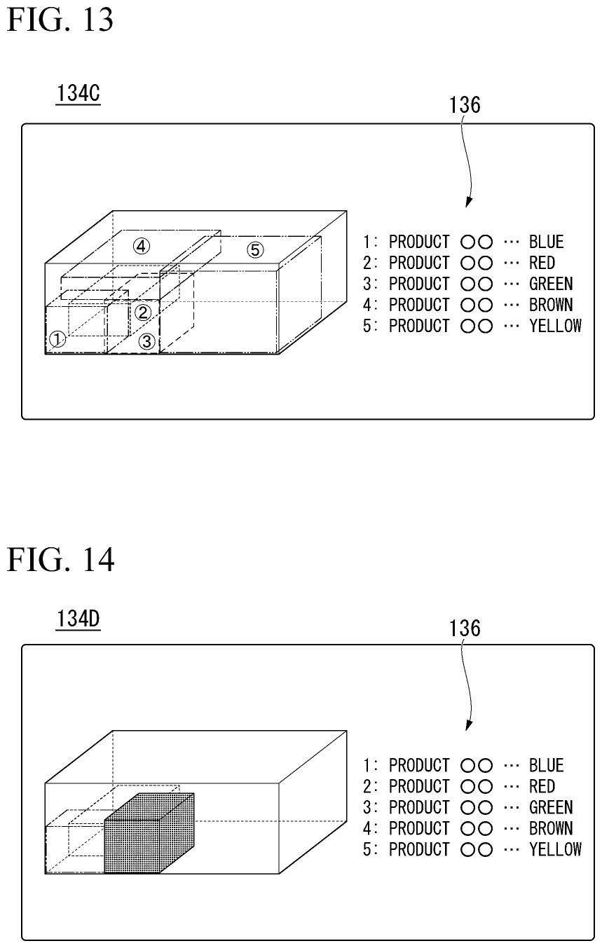

FIG. 13 is a diagram showing an example of the image 134C. The image 134C is an image in which a final form in which all products have been packed in a work material is shown and in which a numeric character indicating a sequence in which each product is packed in a work material is attached to the product. The image having a symbol indicating the sequence attached thereto includes, for example, an image in which a number and a figure representing a product which overlap are displayed, an image in which a product and a number of a sequence are linked using a balloon, and the like. Although a figure of each product is expressed as illustrated in the image 134A in the image 134C, the figure may be expressed as illustrated in the image 134B. Furthermore, in the image 134A, correspondence information 136 obtained by associating a sequence in which products are packed in a work material, a color (or a pattern) of a product displayed in the image 134C, a product name, and the like may be displayed in the image 134D side by side.

FIG. 14 is a diagram showing an example of the image 134D. A plurality of images such as the image 134D are prepared in accordance with the number of products packed in a work material. That is to say, the plurality of images including the image 134D are a series of images according to on-going progress of packaging work. The output controller 177 causes the outputter 130 to output a sequence in which products are packed in a work material using a plurality of images 134D. The example illustrated in FIG. 14 corresponds to an image in which a product packed third is shown in a state in which a product packed first and a product packed second have been packed. In the image 134D, an image of a next product to be packed is represented in a different state from an image of a product which has been already packed. For example, the product which has been already packed is indicated by a dotted line and a product packed next is displayed in a highlighted form as compared with the product which has been already packed. The expression “Next product to be packed” refers to a product which is now a target for packaging work and the expression “Product which has already been packed” refers to a product already packed into a work material which is higher in order in the sequence of products being packed than that of products being worked on.

The correspondence information 136 may also be displayed in the image 134D. When a “next” button has been operated, the output controller 177 generates, for example, a screen in which a display is performed so that the product packed third is indicated by a dotted line and a product packed fourth is highlighted and causes the outputter 130 to output the screen.

The output controller 177 switches between a series of images including the image 134D based on at least one of information indicating a state of work in which a product is packed in a work material (hereinafter referred to as “work state information”) and information indicating accommodation state information of a product accommodated in a work material (hereinafter referred to as “accommodation state information”). For example, the output controller 177 determines whether the process has reached a switching timing based on the work state information or the accommodation state information. In addition, when it is determined that the process has reached the switching timing, the output controller 177 switches the images. The switching timing is a timing at which an immediately previous packing operation has been completed and may be a timing at which an immediately previous packing operation is estimated to have been completed. The timing at which an immediately previous packing operation has been completed is, for example, a timing at which work completion is determined based on a captured image obtained by capturing work by a manipulator B. In addition, the timing at which an immediately previous packing operation is estimated to have been completed is, for example, a timing at which a predetermined time has elapsed from a timing at which an immediately previous image 134D is displayed. For example, the output controller 177 switches a screen displayed in the outputter 130 when the worker B has operated, using the inputter 120, an operator (for example, a button or the like displayed as the term “next”) displayed in the outputter 130 each time a product is packed.

The accommodation state information may be acquired using the acquirer 173 based on, for example, the weighing result obtained by weighing an article placed on the workbench 38. For example, when a weight of an article packed in a packaging material increases by greater than or equal to a certain amount, the acquirer 173 generates information indicating that the accommodation state of a product accommodated in a work material has changed and outputs the information to the output controller 177. The output controller 177 switches the screen displayed in the outputter 130 based on this information. Furthermore, the accommodation state information may be acquired by the acquirer 173 by performing image analysis on a captured image of a camera configured to image the workbench 38 from above. For example, the acquirer 173 may determine whether the next product is packed in the packaging material based on the result of the image analysis. When it is determined that the next product has been packed, the acquirer 173 generates information indicating that the accommodation state of the product accommodated in the work material has changed and outputs the information to the output controller 177. The output controller 177 switches the screen displayed in the outputter 130 based on this information

Also, the output controller 177 may display a final form in which all of the products have been packed in the work material, generate an image 134E in which on-going progress of the packaging work is shown, and cause the outputter 130 to output the displayed final form and the generated image 134E at the same time. The output controller 177 switches the image 143E in which the on-going progress is shown through the same method as in the method of switching the image 134D.

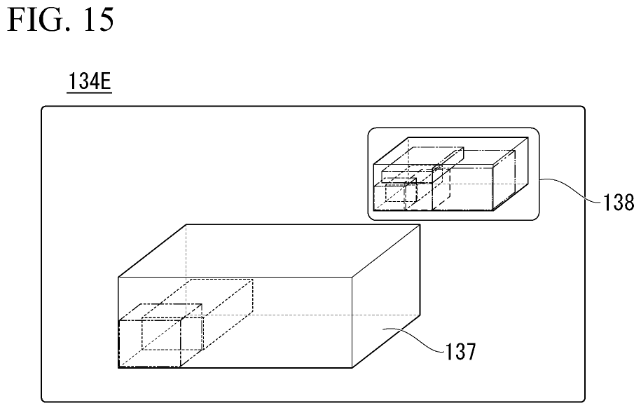

FIG. 15 is a diagram showing an example of the image 134E. In the image 134E, an image 137 in which on-going progress is shown has a product which has been already packed indicated by a dotted line therein. Furthermore, an image 138 in which the final form is shown is an image as shown in the image 134A and may be an image as shown in the image 134B. When the “next” button has been operated, the output controller 177 adds, for example, a diagram of the product which has been already packed to the image 137.

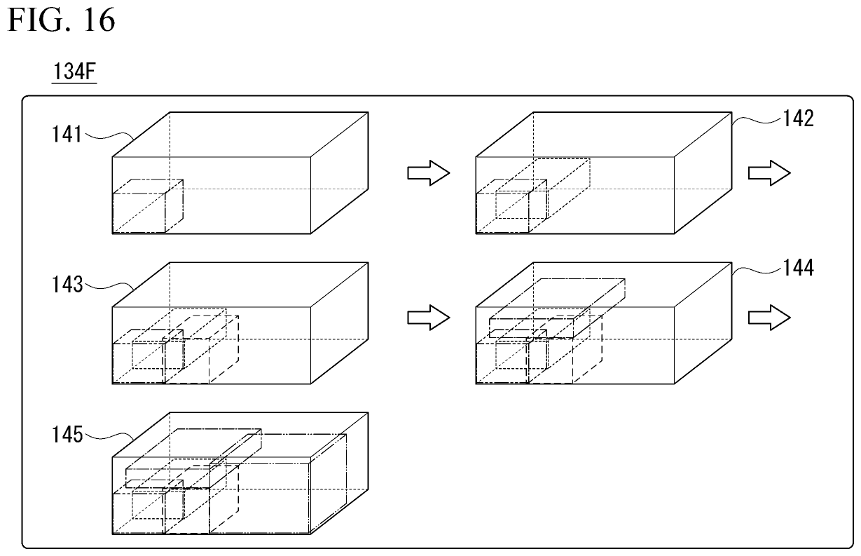

Also, the output controller 177 may generate a series of images 134F and cause the outputter 130 to output the generated series of images 134F. The series of images 134F are a series of images in which on-going progress of work in which products are packed in a work material is shown for each of the products and are a plurality of images arranged side by side in accordance with a sequence in which the products are packed in the work material. FIG. 16 is a diagram showing an example of the series of images 134F. The series of images 134F include images 141 to 145 which will be described below. The images 141 to 145 are diagrams showing the transition of the accommodation state in the packaging material when the products are packed in the work material in sequence. In the images 141 to 145, as in the image 134D described above, a product which has been already packed may be indicated by a dotted line and the products to be packed which are targets may be displayed in a highlighted manner as compared with a product which has been already packed.

Here, the description of the series of images including the image 134D is supplemented with reference to FIG. 16. The image 134D is an image showing work corresponding to an image 143 illustrated in FIG. 16. Before the image 134D is displayed, the output controller 177 first causes the outputter 130 to output, as the image 134D, an image that is the same as an image 141 showing a product packed first. In this state, when the “next” button has been operated, the output controller 177 causes the outputter 130 to output, as the image 134D, an image that is the same as an image 142 showing the product packed first and a product packed second. In this state, when the “next” button has been operated, the output controller 177 causes the outputter 130 to output the image 134D showing the product packed first, the product packed second, and a product packed third. The output controller 177 repeatedly performs this process until an image that is the same as an image 145 showing a final form is displayed as the image 134D.

According to one or more embodiments described above, for each product group including one or more products to be shipped to the same destination, when an acquirer configured to acquire product information pertaining to the products, a determiner configured to determine a type of packaging material in which each product included in the product group is packed among a plurality of packaging materials having different accommodation space sizes and a method of packing each product included in the product group in the determined type of packaging material based on the product information acquired by the acquirer, an outputter configured to output information, and an output controller configured to cause the outputter to output the determination results determined by the determiner are provided, the present invention can contribute to efficiency of the entire distribution.

In the packaging work, the type of packaging material may be selected and the packing method may be determined based on the experience of a worker in many cases. For this reason, packaging materials which are too large for products may be selected or packing methods in which the efficiency of packing work deteriorates may be performed in some cases. According to the packaging assistance device 100 described above, it is possible to solve such problems.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the determiner 175 may determine an optimum solution in a case in which a plurality of solutions are obtained when inequalities are solved (for example, a case in which a plurality of packaging materials in which all products corresponding to a product group ID can be accommodated are obtained or a case in which a plurality of arrangement patterns in which all products corresponding to a product group ID can be accommodated are obtained). Here, the determiner 175 may determine, as an optimum solution, a packaging material in which the conditions determined for each priority criterion are satisfied or may randomly select one solution among a plurality of solutions. In the case in which a packaging material in which the conditions determined for each priority criterion are satisfied is determined as an optimum solution, the determiner 175 determines, as an optimum solution, a packing method according to a packaging material having the smallest size and an arrangement pattern corresponding to this packaging material, for example, in the case of the material size priority. Furthermore, the determiner 175 may stop the calculation of the inequalities at a stage in which the packaging material and the arrangement pattern in which the inequalities are satisfied have been obtained.

The determiner 175 may utilize a method in which a learned model (a trained model) is utilized, instead of a method in which linear programming is utilized. The learned model is stored in, for example, the storage 150. The learned model may be generated using the processor 170. The learned model is a learned model in which an optimized combination of a type of work material and a packing method derived using, for example, the above-described linear programming for each combination of products included in a product group is used as teaching data and learning has been performed in association with product information regarding the products included in the product group.

When the learned model is generated, the processor 170 may determine whether all products can be accommodated in sequence from a packaging material having a small accommodation space based on, for example, product information prepared for learning and may end the process when it is determined that all of the products can be accommodated. Furthermore, the processor 170 may determine whether products can be accommodated while the arrangement of the products is changed and may be made to learn a method in which the largest number of products are accommodated, a method in which an empty space in the accommodated state is minimized, and the like. In addition, the processor 170 may be subjected to learning by weighting an arrangement position of each product with reference to product weight information or the like.

The product information 153 may be information prepared in advance or may be, for example, information acquired during conveyance on the conveyor 20. For example, a camera, a 3D scanner, a laser range finder, and other sensors are installed somewhere on the conveyor 20 and a part of the product information 153 may be generated using the processor 170 based on information detected through these apparatuses.

Also, the packaging assistance device 100 may include a label printer (not shown).

The packaging assistance device 100 controls, for example, the label printer to print destination information and the like on a shipping label for a shipping company corresponding to a work material determined by the determiner 175. Thus, the worker B can mechanize work such as selecting a shipping label in accordance with a work material and performing printing.

Also, the output controller 177 may include information used for guiding a method of performing individual packaging in a guidance screen configured to guide the packing method determined by the determiner 175 when a product in which the individual packaging is required is included. The individual packaging is individual packaging of the product before the product is packed in a packaging material. Furthermore, the output controller 177 may include information used for guiding a type and amount of packaging material and a type and amount of buffer in the guidance screen.

The output controller 177 may include information which guides a deformation method in the guidance screen configured to guide the packing method determined by the determiner 175 when a product which needs to be deformed is included. For example, when a T shirt is folded and packed, information which guides a method of folding the T shirt may be included.

The output controller 177 may display an image displayed on the guidance screen in a display form in which the image is able to rotate 360 degrees or in a display form in which the image is able to be scaled.

Although an example in which the output controller 177 switches a screen to be displayed in the outputter 130 when the “next” button has been operated has been described, the present invention is not limited thereto. For example, the output controller 177 may switch the screen displayed in the outputter 130 when the weight of the article packed in the packaging material increases by greater than or equal to a certain amount based on the weighing result obtained by weighing an article placed on the workbench 38. Furthermore, the output controller 177 may determine whether the next product is packed in the packaging material by performing image analysis on a captured image of a camera obtained by capturing the workbench 38 from above, and when it is determined that the next product has been packed, the screen to be display in the outputter 130 may be switched. In addition, the output controller 177 may switch the screen displayed in the outputter 130 when a certain period of time has elapsed.

Also, the output controller 177 may process at least some of images included in the guidance screen using an AR technique and cause the outputter 130 to output the images. For example, the output controller 177 may acquire a direction of a line of sight of the worker B based on the analysis result of captured data captured using the detecting apparatus 34 and change a direction of a packaging material or a direction of a product in accordance with the direction of a line of sight of the worker B.

Furthermore, when a product in a product group which is the next working target does not reach the packaging area 30 at one time, the output controller 177 may display the details of this on the guidance screen. In this case, the output controller 177 may display a guidance screen when all products are placed.

In addition, the packaging assistance device 100 is connected to a drive mechanism configured to select a packaging material instructed from the packaging material stock 32, and may select a packaging material of a type determined by the determiner 175 by controlling this driving and pass the packaging material to the worker B.

The packaging assistance device 100 is connected to a robot configured to pack a product in a packaging material and may control the robot so that a packaging material of a type determined by the determiner 175 is selected and a product is packed in accordance with the packing method determined by the determiner 175.

Also, in the flowcharts illustrated in FIGS. 9 and 10, the determination in Step S309 may be performed after the process of Step S321 ends.

In the packaging assistance device in the embodiment, for example, as illustrated in FIG. 12, the display displays an image in which a surface of a figure representing the article is represented using an exterior image of the article in an image showing a state in which the products have been packed in the packaging material.

Furthermore, in the packaging assistance device in the embodiment, for example, as illustrated in FIGS. 13 to 16, the display displays an image showing a sequence in which all articles packed in the packaging material determined by the determiner are packed in the packaging material.

In the packaging assistance device in the embodiment, for example, as illustrated in FIG. 13, the display displays an image in which a sequence of figures representing the articles packed in the packaging material is numbered.

In the packaging assistance device in the embodiment, for example, as illustrated in FIG. 16, the display displays a series of images in which on-going progress of work in which the articles are packed in the packaging material determined by the determiner is shown for each of the articles, which are a plurality of images arranged side by side in accordance with a sequence in which the articles are packed in the packaging material.

In the packaging assistance device in the embodiment, when deformable articles are included in the group, the determiner further determines a packaging material in which the articles included in the group are packed based on deformed size information indicating sizes of the articles which have been deformed.

In the packaging assistance device in the embodiment, the determiner determines a packaging material in which the shipping fee for each group is minimized, as a packaging material in which the articles included in the group are packed, based on the comparison result between a shipping fee when all of the articles included in the group are accommodated in one packaging material and a shipping fee when all of the articles included in the group are divided into two or more packaging materials and accommodated.

In the packaging assistance device in the embodiment, the determiner determines a packaging material in which a difference between arrival times of the articles packed in the same packaging material is minimized, as a packaging material in which the articles included in the group are packed, based on packaging position arrival time information indicating a time at which the article included in the group reaches a packaging work position in which work in which the article is packed in the packaging material is performed.

In the packaging assistance device in the embodiment, the determiner determines a packaging material in which the articles included in the group are packed based on the result obtained by inputting the article information to the learned model, and the learned model is a learned model in which, for each combination of the articles included in the group, an optimized combination of the packaging material and a method of packing the article in the packaging material is used as teaching data and learning has been performed in association with the article information regarding the articles included in the group.

Also, in the packaging assistance device in the embodiment, when an article in which individual packaging is required is included in the group, the display displays a method of performing individual packaging on the article.

What is claimed is:

1. A packaging assistance device, comprising:
an acquirer configured to acquire, for each group including one or more articles to be shipped to the same destination, article information pertaining to the articles;
a determiner configured to determine, based on the article information acquired by the acquirer, a packaging material for packing the articles included in the group among a plurality of packaging materials having different accommodation space sizes and a method of packing the articles having a sequence in which the articles included in the group are to be packed in the packaging material; and
a display configured to display information indicating the packaging material and the packing method determined by the determiner.

2. The packaging assistance device according to claim 1, wherein the display displays an image showing a state in which all of the articles packed in the packaging material determined by the determiner have been packed in the packaging material.

3. The packaging assistance device according to claim 1, wherein the display switches between a series of images according to on-going progress of packaging work based on at least one of information indicating a state of work in which the articles are packed in the packaging material or information indicating an accommodation state of the articles accommodated in the packaging material.

4. The packaging assistance device according to claim 3, wherein the series of images includes an image which displays a figure of an article which has been already packed in the packaging material determined by the determiner and a figure of an article to be packed next in different forms.

5. The packaging assistance device according to claim 3, wherein the display displays the series of images and an image showing a state in which all of the articles packed in the packaging material determined by the determiner have been packed in the packaging material.

6. The packaging assistance device according to claim 1, wherein the determiner determines, as a packaging material in which the articles included in the group are to be packed, a packaging material in which a predetermined priority criterion among a plurality of criteria each having different priority items is satisfied among the plurality of packaging materials.

7. The packaging assistance device according to claim 1, wherein the determiner determines, as a packaging material in which the articles included in the group are to be packed, a packaging material in which the articles included in the group are able to be accommodated and which has the smallest accommodation space based on at least one of size information indicating a size of the articles or weight information indicating a weight of the articles.

8. The packaging assistance device according to claim 7, wherein, when an article in which individual packaging is required is included in the group, the determiner further determines a packaging material in which the article included in the group is packed based on packaged size information indicating a size in which the article has been subjected to individual packaging.

9. The packaging assistance device according to claim 1, wherein the determiner determines, as a packaging material in which the articles included in the group are to be packed, a packaging material in which the shipping fee for each group is minimized based on shipping fee information indicating a shipping fee for each of the packaging materials determined in advance in accordance with the accommodation space size, and
the shipping fee information includes information pertaining to shipping fees for two or more different shipping companies.

10. A packaging assistance method, comprising, by a computer:
acquiring, for each group including one or more articles to be shipped to the same destination, article information pertaining to the articles;
determining, based on the article information acquired by the acquirer, a packaging material for packing the articles included in the group among a plurality of packaging materials having different accommodation space sizes and a method of packing the articles having a sequence in which the articles included in the group are to be packed in the packaging material; and
displaying information indicating the packaging material and the packing method determined by the determiner.

11. A non-transitory computer-readable storage medium storing a program for causing a computer to execute:
acquiring, for each group including one or more articles to be shipped to the same destination, article information pertaining to the articles;
determining, based on the article information acquired by the acquirer, a packaging material for packing the articles included in the group among a plurality of packaging materials having different accommodation space sizes and a method of packing the articles having a sequence in which the articles included in the group are to be packed in the packaging material; and
displaying information indicating the packaging material and the packing method determined by the determiner.
